(19) United States
(12) Patent Application Publication
(10) Pub. No.: US 2016/0261523 A1
(43) Pub. Date: Sep. 8, 2016

(54) DYNAMICALLY TUNING SYSTEM COMPONENTS FOR IMPROVED OVERALL SYSTEM PERFORMANCE

(71) Applicant: Apollo Education Group, Inc., San Jose, CA (US)

(72) Inventors: Rajaa Mohamad Abdul Razack, San Jose, CA (US); Narender Vattikonda, Fremont, CA (US); Pavan Aripirala Venkata, Pleasanton, CA (US); Sajithkumar Kizhakkiniyil, Dublin, CA (US); Wei You, Palo Alto, CA (US)

(21) Appl. No.: 14/640,790

(22) Filed: Mar. 6, 2015

(51) Int. Cl. H04L 12/911; H04L 12/26

(52) U.S. Cl. CPC H04L 47/78; H04L 43/0888

(57) ABSTRACT

Resources available to a service node in a system are dynamically modified. The modification is based on current performance levels of other service nodes, application level transactions, resource utilization patterns, and/or in response to detecting a pre-failure conditions.

### TECHNICAL FIELD

The present disclosure relates to dynamically modifying a system. In particular, the present disclosure relates to dynamically modifying resources allocated to a system.

### BACKGROUND

Complex computer systems are generally configured to perform one or more services such as, for example, firewall processing, messaging, routing, encrypting, decrypting, data analysis, and data evaluation. Examples of application level services include administering an examination to students, completing a purchase via an online shopping portal, and registering for a marathon. Systems may include multiple different nodes for performing the services. A node, as referred to herein, includes a software module executing operations using hardware components, a hardware component (for example, a processor), and/or a hardware device (for example, a server). Each node within a system may be uniquely qualified to perform a particular function or may be a redundant node such that multiple nodes perform the particular function.

Performing the services includes propagating data through all of the nodes in the system or a subset of the nodes in the system. In one example, data is processed by a first node that performs a decryption service and thereafter is processed by a second node that performs a firewall service.

In some systems, a particular service may take longer to complete than other services due to, for example, the length of time to perform the particular service, the complexity of the particular service, the bandwidth for communicating with other components regarding the particular service, and/or an insufficient number of resources to perform the particular service.

The approaches described in this section are approaches that could be pursued, but not necessarily approaches that have been previously conceived or pursued. Therefore, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for modifying resources available to service nodes in accordance with one or more embodiments;

FIG. 3 illustrates an example set of operations for modifying resources based on application level transaction(s) in accordance with one or more embodiments;

FIG. 4 illustrates a system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention. The detailed description includes the following sections:
1. GENERAL OVERVIEW
2. ARCHITECTURAL OVERVIEW
3. MODIFYING RESOURCES FOR A FIRST NODE BASED AT LEAST ON PERFORMANCE OF A SECOND NODE
   3.1 DETECTING CURRENT PERFORMANCE CHARACTERISTICS FOR A SET OF SERVICE NODES
   3.2 DETERMINE TARGET PERFORMANCE CHARACTERISTICS OF A FIRST NODE BASED AT LEAST ON CURRENT PERFORMANCE CHARACTERISTICS OF A SECOND NODE
   3.3 DETERMINE IF CURRENT PERFORMANCE CHARACTERISTICS OF A FIRST NODE MEET THE TARGET PERFORMANCE CHARACTERISTIC FOR THE FIRST NODE
   3.4 MODIFY RESOURCES ASSOCIATED WITH THE FIRST NODE IF CURRENT PERFORMANCE CHARACTERISTICS OF THE FIRST NODE DO NOT MEET THE TARGET PERFORMANCE CHARACTERISTICS FOR THE FIRST NODE
4. RESOURCE ALLOCATION BASED ON APPLICATION LEVEL TRANSACTION(S)
5. MODIFYING RESOURCE ALLOCATION IN RESPONSE TO DETECTING PRE-FAILURE CONDITIONS
6. MODIFYING RESOURCE ALLOCATION BASED ON RESOURCE UTILIZATION PATTERNS
7. MISCELLANEOUS; EXTENSIONS
8. HARDWARE OVERVIEW

1. General Overview

One or more embodiments relate to modifying a set of resources in a system. A system includes multiple nodes that perform multiple services. Bottlenecks in a system are created when a particular service takes too long to complete because the particular service takes longer than other services and/or because there are not enough resources available to perform the service. The delay in the particular service results in degradation of overall system performance. Furthermore, systems with bottlenecks generally include nodes that are overloaded and nodes that are under-utilized resulting in degradation of overall system performance.

In one or more embodiments, an end-to-end to analysis is performed on the system to identify bottlenecks within the system and reduce the effect of such bottlenecks. Performance of a node(s) or service(s) is compared against performance metrics. In response to identifying unsatisfactory performance for particular nodes or services, resources (including configurations) are modified to improve performance for the particular nodes or services. The metrics for evaluating any particular node or service may be independently determined or determined in relation to performance of other nodes or services. Modifying resources (including configurations) may involve shifting resources away from node to another node. The shift may result in higher or lower performance at individual nodes, however, the overall system performance is improved by the shifting of resources.

In an embodiment, the target performance characteristics of a first node are determined based on the current performance characteristics of a second node. The resources within the system are modified in order to achieve performance at the first node that meets the target performance characteristics.

2. Architectural Overview

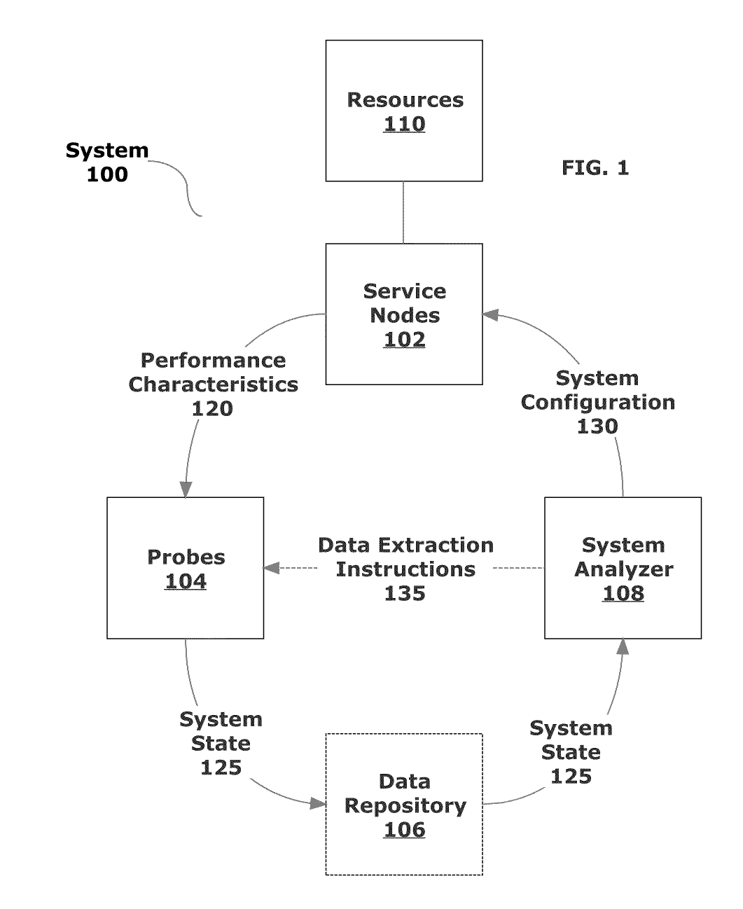

FIG. 1 illustrates a system (100) in accordance with one or more embodiments. Although a specific system is described, other embodiments are applicable to any system that can be used to perform the functionality described herein. Additional or alternate components may be included that perform functions described herein. Components described herein may be altogether omitted in one or more embodiments. One or more components described within system (100) may be combined together in a single device.

Components of the system (100) are connected by, without limitation, a network such as a Local Area Network (LAN), Wide Area Network (WAN), the Internet, Intranet, Extranet, and/or satellite links. Any number of devices connected within the system (100) may be directly connected to each other through wired and/or wireless communication segments. In one example, devices within system (100) are connected via a direct wireless connection such a Bluetooth connection, a Near Field Communication (NFC) connection, and/or a direct Wi-Fi connection.

In an embodiment, system (100) includes service nodes (102), probes (104), a data repository (106), and a system analyzer (108). System (100) also has a set of resources (110) used, for example, by service nodes (102) to perform services. Each of these components may be implemented on a single device or distributed across multiple devices.

In an embodiment, each service node (102) as referred to herein includes hardware and/or software component(s) for performing a service. In an example, a service node (102) refers to a hardware device comprising a hardware processor. In another example, a service node (102) refers to an instance of a software object. The service node (102) may refer to a logical or functional component responsible for performing a particular service.

Each service node (102) performs one or more services corresponding to data processed by system (100). A service includes any higher level or lower level function performed by a system. A particular service may be performed by a single service node (102) or multiple service nodes (102). Examples of services include, but are not limited to, administering a homework assignment for an online course, registering a user for a marathon, completing an online purchase, providing search results for research for a school project, firewall service, encryption service, decryption service, authentication service, fragmentation service, reassembly service, Virtual Local Area Network (VLAN) configuration service, routing service, Network Address Translation (NAT) service, and Deep Packet Inspection (DPI).

To perform a service, a service node (102) typically accesses one or more resources (110). In an embodiment, the resources (110) as referred to herein include hardware based resources, software based resources, and/or configurations. Examples of resources (110) include but are not limited to a Central Processing Unit (CPU), allocated memory, network upload bandwidth, network download bandwidth, a number of connections (e.g., TCP connections), and cache.

In an example, a service node (102) may be allocated a percentage of the total network download bandwidth or a fixed amount such as 2 MB/second. In another example, a service node (102) may be configured with a particular number of TCP connections.

In one example, a resource (110) is a Java Virtual Machine (JVM) that is implemented on a service node (102) and configured for performing one or more services. In this example, a service node (102) is a device, component, or application responsible for performing a service using a single or multiple JVMs.

In an embodiment, the resources (110) as referred to herein include configurations (e.g., priority level, resource allocation level, bandwidth level). In an example, a resource is a high priority connection or a low priority connection. In another example, a resource is a high bandwidth database connection or a low bandwidth database connection.

Resources (110) available to a service node (102) affect the performance associated with a service node (102) that performs one or more services. For example, the resources (110) available to a service node (102) determine how quickly and/or efficiently the service node (102) may complete a particular service. Performance characteristics (120) are values related to the performance of a service node (102) (or performance of service provided by a service node(s) (102)). Examples of performance characteristics include, but are not limited to, throughput, quality, speed, error rate, efficiency, time-to-completion, and queue wait time and queue length.

In an embodiment, probes (104) are sensors which detect performance characteristics (120) related to service nodes (102) (including performance characteristics for services performed by service nodes (102)).

It is contemplated that the probes (104) may be implemented in software or hardware on the machine being monitored, or in hardware that may be placed upstream and/or downstream in the network from the device being monitored. For example, two hardware probes (104) that perform deep packet inspection may work in concert with one another when placed upstream and downstream from the network device being monitored. These probes (104) may compare data resulting from deep packet inspection and a master probe (104) of the two may report the discrepancy. Other probes (104) may operate from remote hardware and or software that is capable of accessing the device and relevant information being monitored via a network connection.

In one example, probes placed in a system detect the throughput of a service node (102) by inspecting an amount of processed data transmitted by the service node (102). In another example, probes detect a time to completion by detecting a time at which data is transmitted to a service node (102), and a time when the same or related data (e.g., encrypted version of the data or filtered version of the data) is transmitted out from the service node (102). Probes can detect dynamic information (real-time throughput) and/or static information (e.g., a number of configured connections).

Examples of probes include, but are not limited to:

| | Possible Function |
|---|---|
| Possible Probe Name | (Non-limiting examples) |
| RDMBSConnectionProbe | Reads the connection pooling |
| | setting for RDBMS and |
| | recommends any other settings if |
| | not set; for each database there may |
| | be a separate |
| | RDBMSConnectionProbe |
| NodeCapacityProbe | Checks the capacity for performing |
| | a service such as a number of |
| | service nodes, CPU capacity, and |
| | memory allocation; the information |
| | indicates if the number of nodes or |
| | the capacity of a service node is |
| | enough for a current load |
| ThroughputProbe | Reads the throughput of the |
| | requests to a service node |
| JVMSettingProbe | Reads the JVM Settings (e.g., min, |
| | max, gc settings) and the current |
| | usage of the JVM to observe each |
| | of the Heap spaces |
| TCPProbe | Checks for the number of TCP |
| | connections in CLOSE_WAIT state |
| CacheUsageProbe | Checks the usage of the cache |
| CustomProbe | Can be customized by providers of |
| | a service; an example includes |
| | detecting a particular error |
| | condition that causes closing of |
| | connections to a 3^{rd} party server and |
| | periodically transmitting a |
| | corresponding report |

In an embodiment, the data repository (106) corresponds to any local or remote storage device. Access to the data repository (106) may be restricted and/or secured. In an example, access to the data repository (106) requires authentication using passwords, certificates, biometrics, and/or another suitable mechanism. Those skilled in the art will appreciate that elements or various portions of data stored in the data repository (106) may be distributed and stored in multiple data repositories. In one or more embodiments, the data repository (106) is flat, hierarchical, network based, relational, dimensional, object modeled, or structured otherwise. In an example, data repository (106) is maintained as a table of a SQL database and verified against other data repositories.

In an embodiment, the data repository (106) stores the system state (125) as determined by probes (104). The system state (125) includes a collection of performance characteristics (120) detected by probes (104) and/or data associated with the performance characteristics (120). In one example, probes (104) filter the collected performance characteristics (120) to identify a subset of the collected performance characteristics (120) related to identifying a bottleneck in system (100). The probes store the subset of the performance characteristics (120) in the data repository (106) for faster or prioritized evaluation.

In an embodiment, the data repository (106) stored information related to the allocation of resources (110). In an example, the data repository (106) stores configuration information for each JVM implemented on the services nodes (102). In an embodiment, the data repository (106) stores patterns or historical trends related to usage of the resources by various service nodes (102) at various times or during performance of various services. In one example, the data repository (106) stores the usage of all the resources during a user's registration process for a marathon.

In an embodiment, system analyzer (108) corresponds to any combination of software and hardware components that includes functionality to generate a system configuration (130) based on the system state (125). The system analyzer (108) obtains the system state (125) from data repository (106) or directly from probes (104). In one example, probes (104) and system analyzer (108) are implemented on the same device and/or within a same application. The system analyzer (108) may provide data extraction instructions (135) to probes (104) to extract specific information relevant to the analysis performed by the system analyzer (108).

The system configuration (130) specifies resources (110) to be made available to service nodes (102) and/or includes configuration of one or more service nodes (102). System configuration (130) generated by system analyzer (108) may include a complete configuration or changes to an existing configuration. System analyzer (108) generates system configuration (130) continually, periodically, in response to events, or accordingly to another scheduling scheme.

3. Modifying Resources for a First Node Based at Least on Performance of a Second Node

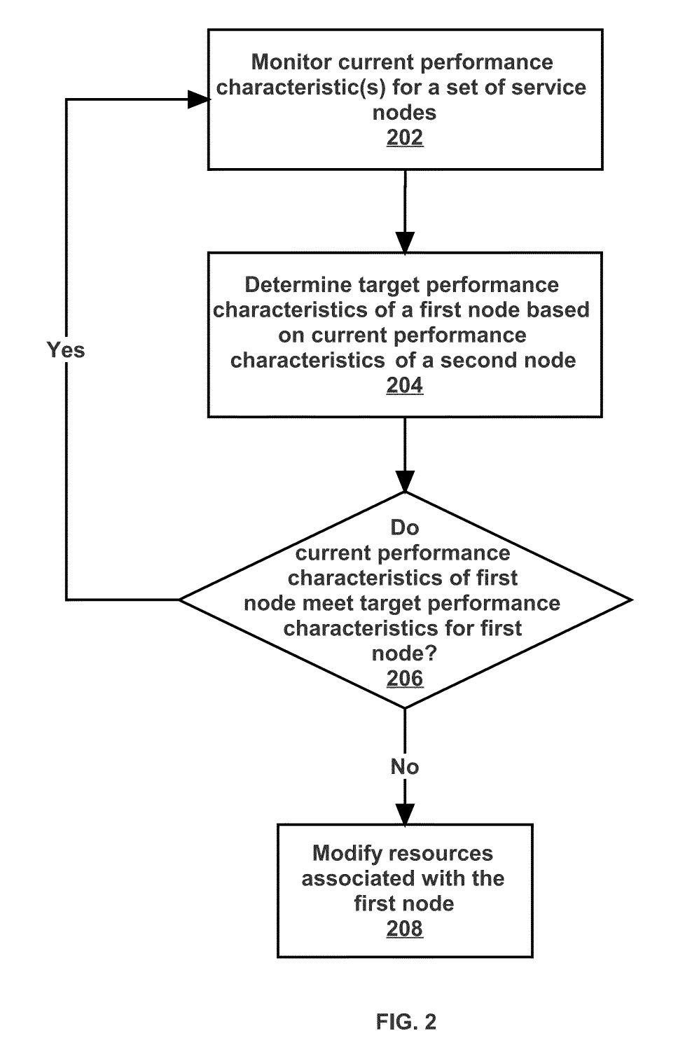

FIG. 2 illustrates an example set of operations for modifying resources available to service nodes. Operations for modifying resources available to service nodes, as described herein with reference to FIG. 2, may be omitted, rearranged, or modified. Furthermore, operations may be added or performed by different components or devices. Accordingly, the specific set or sequence of operations should not be construed as limiting the scope of any of the embodiments.

3.1 Detecting Current Performance Characteristics for a Set of Service Nodes

In an embodiment, current performance characteristics for a set of service nodes is detected (Operation 202). Detecting current performance characteristics for a set of service nodes includes detecting performance associated with an individual service node, monitoring performance associated with a group of service nodes, and monitoring performance of a service or services performed by a service node(s). Measuring performance characteristics includes, but is not limited to, measuring throughput, quality, speed, error rate, efficiency, time-to-completion, queue wait time and queue length.

In an example, detecting the current performance characteristics for a group of service nodes includes identifying a group of service nodes that perform encryption services and detecting an aggregated throughput of encrypted data transmitted by the group of services during a particular period of time.

In an example, a queue for Deep Packet Inspection (DPI) performed by a particular service node is monitored. A time when packets enter the queue is recorded using information from the packet header to index the recorded data. Furthermore, a time when DPI is initiated for the packets and/or when DPI is completed for the packets is also recorded. The time difference between when the packets enter the queue and when DPI is initiated is computed to determine a queue wait time. The queue wait time for a set of packets inspected during a given time period is averaged to determine an average wait time for the service node performing the DPI. In a related example, the DPI processing is completed by three different service nodes. The average wait time is computed as an average of wait times for processing of packets by any of the three service nodes.

In an embodiment, detecting performance characteristics of a service node includes detecting resources used by the service node to perform a service. In an example, a Central Processing Unit (CPU) used by a service node is monitored to determine a level of utilization over a period of time (for example, 40% of capacity, 80% of capacity, and 99% of capacity). The level of utilization of one or more resources can be used to determine whether there are enough resources available for the service node. In this particular example, if the average level of utilization for a CPU is over 90%, a high likelihood of the CPU being utilized at 100% of capacity during peak times is determined. Alternatively, a percentage of time when the CPU utilization is over a particular threshold (for example, 95%) is determined and identified as a time period when the CPU is overloaded.

In an example, detecting performance characteristics includes monitoring usage statistics associated with cache. In an example, a number of cache hits, and cache misses is identified and recorded. In another example, a number of times that a same data set is requested within a particular period of time is determined and recorded.

In an example, each heap space corresponding to a Java Virtual Machine (JVM) is monitored. The monitoring includes identifying a level of utilization and/or a level of fragmentation associated with the heap space.

In one example, a number of TCP connections in CLOSE_WAIT state is monitored. In this example, a number of TCP connections in CLOSE_WAIT is determined periodically during a period of time and based on the readings taken periodically during the period of time, an average number of TCP connections in CLOSE_WAIT time during the period of time is determined.

3.2 Determine Target Performance Characteristics of a First Node Based at Least on Current Performance Characteristics of a Second Node

In an embodiment, target performance characteristics for a first node are determined based at least on the current performance characteristics of a second node (Operation 204). The target performance characteristics are determined for the first node such that the first node does not function as a bottleneck for a system. The target performance characteristics for the first node may be determined based on current performance characteristics of multiple other nodes.

A bottleneck occurs when the performance of an application or a system is reduced by a node which completes respective tasks at a much lower level of throughput than other nodes. While differences in throughput are common across various nodes in a system, a significantly lower throughput at a first node than a second node results in the first node becoming a bottleneck. A significant difference in throughput results in the first node executing at maximum capacity while the second node is often idle or underutilized. Target performance characteristics are determined for the first node such that the difference in throughput between the first node and the second node is less than a threshold value.

In an example, a target throughput (target performance characteristic) of a first node is computed based on a detected throughput of a second node that is located prior to the first node on a data processing path. In this example, the second node performs firewall service by filtering incoming data for a system. The filtered set of data, approved by the second node for further processing, is forwarded by the second node to the first node which is configured to perform Deep Packet Inspection (DPI). It is desirable to implement a system in which the second node performs DPI at a rate which keeps up (within an acceptable range) with the rate at which the second node is forwarding filtered data to the first node. If the first node performs DPI at the rate at which the second node forwards the filtered data to the first node, the data flows through both nodes without the first node becoming a bottleneck for the system. However, if the first node performs DPI at a slower rate than the rate at which the second node forward the filtered data to the first node, the first node becomes a bottleneck. Specifically, a queue of filtered data to be inspected by the first node using DPI grows longer and longer as the first node is unable to keep up with a demand for DPI.

In an embodiment, a target performance characteristic for a first node specifies a maximum number of errors by the first node. Examples of errors as referred to herein include, but are not limited to, cache misses, dropped packets, packet errors, and dropped connections. In one example, the target performance characteristics of a first node defines a maximum cache miss rate that is 140% of the cache miss rate of a second node. If the cache miss rate for the first node is significantly higher than the cache miss rate for the second node, it is likely that the first node will have significantly more calls to a secondary storage device than the second node. The first node may become a bottleneck due to the delays caused by accessing the secondary storage.

In an embodiment, a target performance characteristic of a first node is within a particular range of a detected performance characteristic of a second node that performs a same service as the first node. In an example, a target rate of packet encryption by a first node is determined based on a detected rate of packet encryption by a second node. In the example, the second node encrypts 1000 packets per second. The target packet encryption by the first node is 10% higher (1100 packets per second) to 10% lower (900 packets per second) than the packet encryption rate of the second node. Substantially similar rates of encryption indicate that resources are balanced well between the first node and the second node. If the first node underperforms the second node by a substantial amount (for example, a difference of 500 packets per second), then the first node may not have a sufficient number of available resources or may have an error (e.g., broken connection) preventing the first node from using all available resources.

3.3 Determine if Current Performance Characteristics of a First Node Meet the Target Performance Characteristics for the First Node

In an embodiment, the current performance characteristics for the first node are compared to the target performance characteristics for the first node to determine if the current performance characteristics for the first node meet the target performance characteristics for the first node (Operation 206).

In an example, a target throughput at the first node is compared to an actual throughput at the first node. The target throughput for a first node based on detected performance of a second node, may indicate that at least 200 MB of data must be processed per second. If the actual throughput of the first node is 150 MB per second, then the actual throughput fails to meet the target throughput. If the actual throughput of the first node is 250 MB per second, then the actual throughput meets the target throughput.

In another example, an average length of a queue at the first node is compared to target queue length at the first node. The length of the queue at the first node is periodically identified by a probe on the first node. An average of all readings is computed to determine the average queue length at the first node. If the average queue length falls within a range specified by the target queue length, the target performance characteristics are met. If the average queue length falls outside of the range specified by the target queue length, the target performance characteristics are not met.

In one example, a target performance characteristic is a time-to-completion for each data set that propagates through a system. In an example, an association process of a tablet with a wireless access point (WAP) involves both (a) an authentication process and (b) a state transfer process during which the wireless access point obtains information for the tablet from prior connections with other network devices. The authentication process executing on the WAP performs the authentication process by obtaining data from the tablet and communicating with an authentication server to perform a 0.1× authentication procedure. The state transfer process executing on the WAP uses the MAC address of the tablet and retrieves information for the tablet from a client state data repository. The authentication process takes a first period of time for completion and the state transfer process takes a second period of time for completion. The target performance characteristic for the authentication process limits the first period of time at a maximum of 130% of the second period of time used by the state transfer process. If, on average, the first period of time taken by the authentication process is more than 130% of the second period of time taken by the state transfer process, then the first period of time (i.e., time for completion for authentication) fails to meet the target performance characteristics for the authentication process.

3.4 Modify Resources Associated with the First Node if Current Performance Characteristics of the First Node do not Meet the Target Performance Characteristics for the First Node

As noted above, the comparison of the detected current performance characteristics of the first node to the target performance characteristics of the first node indicates whether the detected current performance characteristics of the first node meet the target performance characteristics of the first node. If the detected current performance characteristics do not meet the target performance characteristics, the resources associated with the first node are modified (Operation 208).

In an embodiment, modifying resources associated with the first node includes adding additional resources. In one example, a number of CPU cycles available to the first node are increased. The CPU cycles may be increased by modifying a number of reserved CPU cycles. In another example, a heap allocation for a JVM associated with the first node is increased. In yet another example, additional JVMs associated with the first node are initiated for performing services associated with the first node.

In one example; the first node is a Wireless Access Point (WAP) configured to wirelessly connect to a particular network device for performing a service. Multiple devices compete for a wireless channel to transmit data. A determination is made that the performance of the WAP falls below the target performance characteristics, and that additional airtime is to be allocated to the WAP. In this example, the random back-off time for requesting channel access is shortened to increase a frequency with which the WAP is able to gain access to the wireless channel and transmit data to the particular network device.

In an embodiment, modifying resources associated with the first node includes adding additional nodes to perform the same services as the first node. In an example, a determination is made that the database access operations are functioning as a bottleneck for the system. Specifically, an average amount of time for completing a database access operation exceeds a target average value for completing database access operations. The first node working at maximum capacity is overloaded with requests due to an ongoing class in which students are downloading questions for an examination. As a result, the first node is unable to keep up with a queue for database access operations as requested by applications executing students' machines. Modifying the resources includes initiating another node which also performs database access operations. As a result, the load associated with database access operations is distributed among multiple nodes and the average amount of time for completing a database access operation is lowered under the target average value for completing database access operations.

In an embodiment, resource addition operations are executed in order of lowest performing nodes. In an example, a system includes five nodes where an average time-to-completion for services performed by each of the five nodes is as follows: 1^{st} Node: 0.2 seconds; 2^{nd} Node: 0.9 seconds, 3^{rd} Node: 0.4 seconds, 4^{th} Node: 0.8 seconds, 5^{th} Node: 0.2 seconds. Each of the five nodes use the same set of resources and have equal access to the set of resources. However, operations performed by the 2^{nd} node and the 4^{th} node take longer than operations performed by the 1^{st} node, 3^{rd} node, and 5^{th} node. As a result, the 2^{nd} node and 4^{th} node become bottlenecks for the system while the 1^{st} node, 3^{rd} node, and 5^{th} node are often idle. Specifically, while data is quickly processed at the 1^{st} node, 3^{rd} node, and 5^{th} node, data is often queued up at the 2^{nd} and 4^{th} node causing delay in overall system throughput. Based on the performance characteristics of all the nodes, a target performance characteristic identifies 0.6 seconds as the target time-to-completion for each node. In order to achieve the 0.6 seconds time to completion, resources are shifted from 1^{st} node, 3^{rd} node, and 5^{th} node to the 2^{nd} node and 4^{th} node. The 1^{st} node, 3^{rd} node, and 5^{th} node have lower resource availability than the 2^{nd} node and 4^{th} node. As a result of unequal resource distribution, the 2^{nd} node and 4^{th} node are no longer waiting for resources. The increased availability of resources lowers the time to completion to 0.6 seconds for both the 2^{nd} node and the 4^{th} node. In addition, the time to completion for each of the 1^{st} node, 3^{rd} node, and 5^{th} node increases by one second as fewer resources are available. However, the overall system performance is improved because the queue length at the 2^{nd} and 4^{th} node has been decreased.

In an embodiment, if the detected current performance characteristics do not meet the target performance characteristics, a recommendation is made to modify the resources associated with the first node. The recommendation may include transmitting a notification or an alert to a system administrator. In an example, the recommendation may be displayed on a screen, played via an audio speaker, or transmitted in a message.

4. Resource Allocation Based on Application Level Transaction(s)

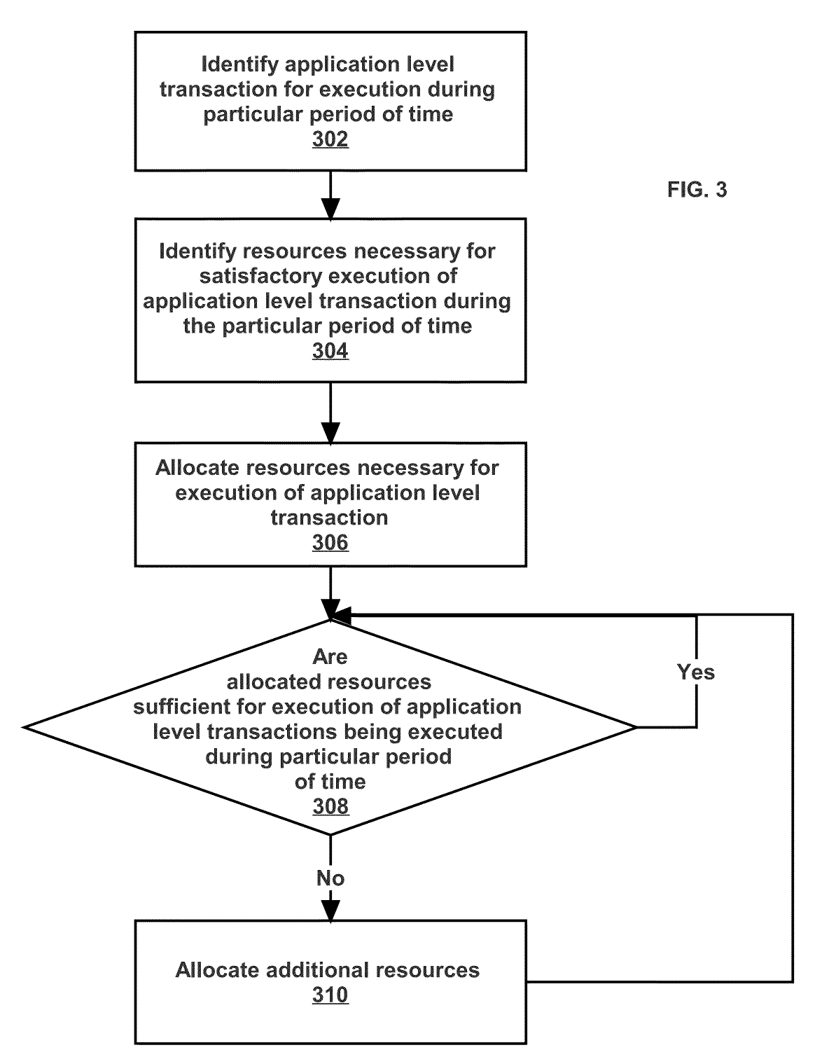

In an embodiment, resources for a first node (including resources for a service performed by the first node) are allocated based on detected and/or expected application level transactions. FIG. 3 illustrates an example set of operations for modifying resources based on application level transaction(s). Operations for modifying resources available to service nodes, as described herein with reference to FIG. 3, may be omitted, rearranged, or modified. Furthermore, operations may be added or performed by different components or devices. Accordingly, the specific set or sequence of operations should not be construed as limiting the scope of any of the embodiments.

Application level transactions, as referred to herein, include any tasks to be performed by an application executing at Layer 7 of the Open System Interconnection (OSI) model. In an example, a browser executing on a client device (or a standalone application executing on the client device) performs the application level transactions of verifying a user and administering an examination. Furthermore, an instance of a web server executing on a hardware server machine may perform application level transactions that communicate with the browser executing on the client device. Application level transactions may be referred to as business transactions.

In an example, an application level transaction is related to a purchase on an online shopping page. The purchase requires a user to first log-in during which a web server receives client information from a client device. The web server transmits the client information to an authentication server via a connection from a set of available connections with the authentication server. The authentication server verifies the user based on the client information. The purchase also involves the web server executing queries related to search terms entered by the user and provided by the client device to the web server. The web server accesses a database stored on local memory (using I/O bandwidth) and performs the query (using CPU cycles). The web server transmits the search results to the client device (using network bandwidth). The user selects a product for purchase and provides payment information via the browser executing on the client device. The web server completes the transaction by communicating with a payment system. As noted above, various resources are utilized by the application level transaction. Application level transactions are broken down into many different tasks (e.g., disk I/O, packet transmission, a four way handshake, encryption, decryption, etc.) that use many resources (memory, CPU cycles, network bandwidth, etc.). Additional examples of tasks and respective resources used by such tasks are described throughout this application. An increase in the number of application level transactions (for example, in December when many users are shopping for presents), will result in an increased demand for resources that are necessary to complete the application level transactions within an acceptable level of latency, security and errors. The description below with reference to FIG. 3 provides example methods for increasing resources to satisfactorily complete such application level transactions.

In an embodiment, an application level transaction is identified for execution at a particular time or during a particular period of time (Operation 302). Execution of the application level transaction requires utilization of resources that are necessary to complete the OSI Layer 1 through Layer 6 tasks that together complete the OSI Layer 7 application level transaction.

In an embodiment, the application level transaction is identified in advance of the particular period of time/in advance of commencing. In an example, an application level transaction includes a virtual classroom session in which a teacher discusses a lesson via a chatroom application. Students log into the chatroom application, view the information provided by the teacher and submit questions via messages to the teacher. The virtual classroom session is scheduled on Monday and Wednesday of every week at 10 am. Based on the schedule, the application level transactions historically executed during the classroom session are anticipated by the system at 10 am every Monday and Wednesday.

In an embodiment, the application level transaction may be identified during the particular period of time as soon as the application level transaction commences. In an example, probes within a system determine a particular set of operations signal the beginning of an application level transaction including a large set of operations. The probes may indicate that a user is logging into an online course when an online examination has been posted by a professor and further indicate that the user has not yet taken the examination. Based on the information provided by the probes, a determination is made that the application level transaction of administrating an examination has commenced. The administration of the examination uses a particular large set of resources.

In an embodiment, resources necessary for satisfactory execution of the application level transaction during the particular period of time are identified (Operation 304). Identifying the resources necessary for satisfactory execution of the application level transaction includes identifying resources such that the application level transaction are executed, for example, within acceptable levels of latency, security, and errors.

Identifying resources necessary for execution of the application level transaction may include identifying resources necessary for execution of all system transactions expected or estimated to occur during particular period of time. Historical resource usage patterns for expected transactions as identified by probes may be analyzed to determine a total expected system resource usage. In an example, a Java Virtual Machine is expected to execute five different application level transactions at 10 am on Wednesday. Network bandwidth necessary to concurrently execute the five different application transactions within acceptable levels of latency is determined based on prior executions of each of the five different application transactions.

In an example, a system determines low resource usage and high resource usage by multiple application level transactions. The system determines the total resource allocation necessary to satisfactorily complete the multiple application level transactions and allocates resources to ensure the satisfactory completion of the multiple application level transactions.

In an embodiment, the resources necessary for execution of the application level transaction during the particular period of time are allocated to the node(s) performing the application level transaction (Operation 306). Allocation of the resources includes allocation of sufficient resources for execution of all the application level transactions during the particular period of time. Examples of allocating resources include but are not limited to modifying configurations, spinning up new Java Virtual Machines (JVMs), allocating additional heap space, allocating additional CPU cycles, allocating additional TCP connections, modifying priority levels associated with nodes, reserving I/O bandwidth for service nodes, and reserving network bandwidth for service nodes.

In an embodiment, allocating resources includes allocating additional resources for a temporary period of time during which an increase in application level transactions is detected or expected. In an example, an amount of memory allocated for buffering data streams is increased when a major sports event is being broadcasted to a large number of viewers. Errors in transmission due to network congestion may be better resolved using a buffer that stores a large amount of error correction data to be transmitted to client devices receiving the data streams. Allocation of resources may be scheduled in advance of execution of the application level transaction.

During the particular period of time in which the application level transactions are being executed, the usage of corresponding resources is periodically or continually monitored. If the resources are found to be insufficient to satisfactorily complete the application level transactions (Operation 308), additional resources may be allocated (Operation 310). Configurations and/or resources may be continually or periodically modified until satisfactory performance is detected.

5. Modifying Resource Allocation in Response to Detecting Pre-Failure Conditions

In an embodiment, characteristics of an upcoming failure are determined so that the system can be modified prior to such a failure. The characteristics are determined based on historical data identifying occurrence of the characteristics followed by a subsequent failure.

In an embodiment, characteristics of an upcoming failure are based on utilization thresholds. In an example, detecting utilization of a resource over 85% continuously over a two minute period is configured as a pre-failure characteristic. When a probe monitoring TCP connections configured for a JVM executing on a server detects that over 85% of the available connections to a database are used continuously over a two minute period, a determination is made that the JVM is unable to or will be unable to handle all incoming requests. In response, additional connections to the database are configured for the JVM.

In another example, a JVM is assigned 25% of the CPU cycles of a hardware CPU in a system. Monitoring the JVM includes determining that the JVM is using, on average, over 90% of the CPU cycles allocated to the JVM (i.e., over 22.5% of the 25% of cycles allocated to the JVM). The high level of utilization indicates that the JVM is unlikely to perform all necessary functions within an acceptable level of latency, security, and errors. In response to detecting the high level of utilization, the JVM is allocated 40% of the total CPU cycles of the hardware CPU in the system.

6. Modifying Resource Allocation Based on Resource Utilization Patterns

In an embodiment, resource allocation is modified according to detected utilization patterns. In an example, the utilization of resources by a service node, executing on a client device, is monitored for identification of patterns. The service node implements a module for navigating a user to a destination. Monitoring the service node reveals that usage spikes on Saturdays and Sundays when users are navigating to new locations (for example, new restaurants, new tourist destinations, etc.). The monitoring further reveals that the CPU usage by the service node spikes as the service node is continuously computing a location of the client device while navigating a user to a new location. In response to detecting the pattern of high usage on Saturdays and Sundays, a system configuration is modified to allocate additional CPU cycles to the JVM corresponding to the service node.

In another example, a first node is configured for administering examinations by managing a user's experience. The first node is a web server configured for obtaining and transmitting web pages to a user for obtaining user log-in information, presenting questions, and obtaining answers from the user. While the online examinations may be taken at any time during a one week period, heavy usage is generally detected on the last day for each examination period. Due to the heavy usage by students on the last day of the examination period, the web server and corresponding resources are overloaded. Students taking the examination on the last day of the examination period experience a high level of latency. Other services provided by the web server such as administration of tutorials and homework also experience a high level of latency on the last day of the examination period even though there is no spike in the administration of tutorials and homework. Based on the spike due to the application level transaction of administering examinations on the last day of the examination period, additional resources are allocated on the last day of the examination period that are used for administering the examinations.

7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

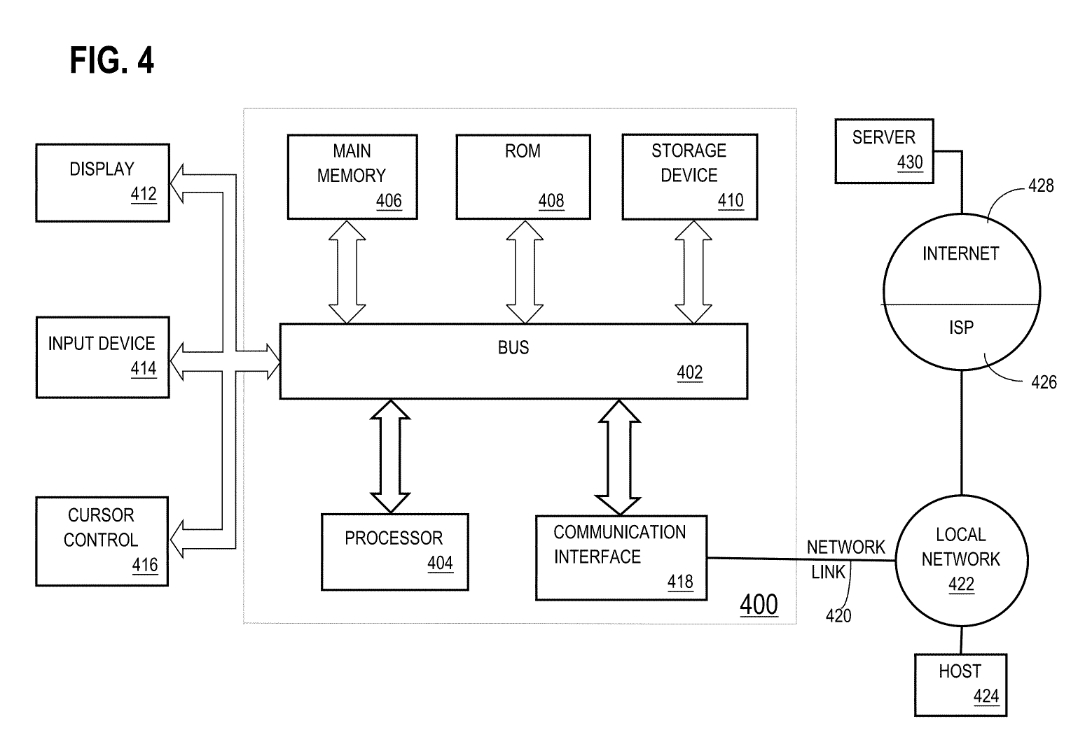

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 440, such as a magnetic disk or optical disk, is provided and coupled to bus 402 for storing information and instructions.

Computer system 400 may be coupled via bus 402 to a display 442, such as a cathode ray tube (CRT), for displaying information to a computer user. An input device 444, including alphanumeric and other keys, is coupled to bus 402 for communicating information and command selections to processor 404. Another type of user input device is cursor control 446, such as a mouse, a trackball, or cursor direction keys for communicating direction information and command selections to processor 404 and for controlling cursor movement on display 442. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 440. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 440. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 440 either before or after execution by processor 404.

Computer system 400 also includes a communication interface 448 coupled to bus 402. Communication interface 448 provides a two-way data communication coupling to a network link 420 that is connected to a local network 422. For example, communication interface 448 may be an integrated services digital network (ISDN) card, cable modem, satellite modem, or a modem to provide a data communication connection to a corresponding type of telephone line. As another example, communication interface 448 may be a local area network (LAN) card to provide a data communication connection to a compatible LAN. Wireless links may also be implemented. In any such implementation, communication interface 448 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 448, which carry the digital data to and from computer system 400, are example forms of transmission media.

Computer system 400 can send messages and receive data, including program code, through the network(s), network link 420 and communication interface 448. In the Internet example, a server 430 might transmit a requested code for an application program through Internet 428, ISP 426, local network 422 and communication interface 448.

The received code may be executed by processor 404 as it is received, and/or stored in storage device 440, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A non-transitory computer readable medium comprising instructions which, when executed by one or more hardware processors, causes performance of operations comprising:
detecting one or more current performance characteristics for a plurality of nodes in a system;
determining one or more target performance characteristics for a first node, in the plurality of nodes, based at least on the current performance characteristics of a second node in the plurality of nodes;
determining whether the current performance characteristics for the first node meet the target performance characteristics for the first node;
responsive to determining that the current performance characteristics for the first node do not meet the target performance characteristics for the first node, modifying a set of one or more resources allocated to the first node.

2. The medium of claim 1, wherein the operations further comprise:
detecting a change in the current performance characteristics of the second node;
modifying the target performance characteristics for the first node based on the change in the current performance characteristics of the second node.

3. The medium of claim 1, wherein current performance characteristics of the first node and the current performance characteristics of the second node correspond to values measuring different performance characteristics.

4. The medium of claim 1, wherein the current performance characteristics of the second node comprise a throughput measurement.

5. The medium of claim 1, wherein the current performance characteristics of the first node comprise a utilization level of the set of one or more resources.

6. The medium of claim 1, wherein modifying the set of one or more resources associated with the first node comprises modifying a configuration of a Virtual Machine (VM) instance associated with the first node.

7. The medium of claim 1, wherein modifying the set of one or more resources associated with the first node comprises adding additional nodes that perform a same function as the first node.

8. The medium of claim 1, wherein responsive to determining that the one or more current performance characteristics of the second node meets the modification criteria, the operations comprise: modifying the set of one or more resources associated with the second node.

9. The medium of claim 1, wherein modifying the set of one or more resources associated with the first node comprises increasing a number of connections between the first node and one or more other devices.

10. The medium of claim 1, wherein modifying the set of one or more resources associated with the first node comprises increasing an amount of time per time period during which the first node has access to the set of one or more resources.

11. The medium of claim 1, wherein modifying the set of one or more resources associated with the first node comprises modifying a bandwidth available to the first node for communicating with one or more other components.

12. The medium of claim 1, wherein modifying the set of one or more resources associated with the first node comprises modifying an amount of memory allocated to the first node.

13. The medium of claim 1, wherein determining the target performance characteristics for the first node is based further on the current performance characteristics of a third node in the plurality of nodes.

14. The medium of claim 1, wherein modifying a set of resources allocated to the first node comprises shifting a portion of allocation corresponding to the set of resources from the second node to the first node.

15. A non-transitory computer readable medium comprising instructions which, when executed by one or more hardware processors, causes performance of operations comprising:
identifying an application level transaction to be executed or currently executing, during a particular period of time, by an application executing at Open System Interconnection (OSI) Layer 7;
mapping the application level transaction to one or more resources that will be required to complete the application level transaction;
increasing allocation of the one or more resources, for the application or for a service node executing the application, at least during the particular period of time.

16. The medium of claim 15, wherein identifying the application level transaction, mapping the application level transaction, and scheduling the increased allocation of the one or resources is completed prior to beginning an execution of the application level transaction.

17. A non-transitory computer readable medium comprising instructions which, when executed by one or more hardware processors, causes performance of operations comprising:
monitoring utilization of one or more resources by one or more service nodes in a plurality of service nodes;
determining that utilization of the one or more resources, by the one or more service nodes, matches a pre-failure condition;
responsive to determining that the utilization of the one or more resources matches a pre-failure condition, allocating additional resources to the one or more service nodes.

18. The medium of claim 17, wherein allocating additional resources comprises initiating new Virtual Machines (VMs) for performing services being performed by the service nodes.

19. A non-transitory computer readable medium comprising instructions which, when executed by one or more hardware processors, causes performance of operations comprising:
monitoring utilization of one or more resources by one or more service nodes in a plurality of service nodes;
identifying a pattern in the utilization of the one or more resources, the pattern identifying periods of time during which the utilization exceeds a particular threshold;
based on the pattern, allocating additional resources to the one or more service nodes during the periods of time during which the utilization exceeds the particular threshold.

20. The medium of claim 19, wherein allocating additional resources comprises initiating new Virtual Machines (VMs) for performing services being performed by the service nodes.
